(19) United States
(12) Patent Application Publication
(10) Pub. No.: US 2014/0223736 A1
(43) Pub. Date: Aug. 14, 2014

(54) Method of Manufacturing Camshaft

(71) Applicant: Mibo Co., Ltd., Hwaseong-si (KR)

(72) Inventors: Yong Kyoon Kim, Suwon-si (KR); Yung Sang Park, Pyeongtaek-si (KR); Jun Ho Song, Pyeongtaek-si (KR); Dong Kyu Han, Pyeongtaek-si (KR); Young Ho Kim, Pyeongtaeki-si (KR)

(73) Assignee: Mibo Co., Ltd, Hwaseong-si (KR)

(21) Appl. No.: 14/348,236

(22) PCT Filed: Sep. 27, 2012
(86) PCT No.: PCT/KR2012/007877

§ 371 Date: Mar. 28, 2014

(30) Foreign Application Priority Data
Sep. 28, 2011 (KR) 10-2011-0097973

(51) Int. Cl. B23P 15/00

(52) U.S. Cl. CPC B23P 15/00; B23P 2700/02
USPC 29/888.1

(57) ABSTRACT

Disclosed herein is a method of manufacturing a camshaft. Particularly, the present invention relates to a method of manufacturing a camshaft which includes a single sintering operation and a brazing operation, thus reducing the time for manufacturing.

### TECHNICAL FIELD

The present invention relates, in general, to methods of manufacturing camshafts and, more particularly, to a method of manufacturing a camshaft which uses a brazing process, thus reducing the time for manufacturing.

### BACKGROUND ART

Generally, a camshaft is provided with a plurality of cams which are provided on the shaft in different phases at positions spaced apart from each other at predetermined intervals. The camshaft is repeatedly rotated by rotational force of a crankshaft, thus periodically opening and closing an air-intake valve and an air-release valve of a combustion chamber so that the engine can be continuously operated.

Such conventional camshafts are manufactured in an integrated rod type in which both a cam and a shaft are integrally formed of the same material, or in an assembly type in which a cam manufactured by a separate process is joined with a shaft in a variety of manners.

The assembly type hollow camshaft can be lighter than the integrated camshaft. Furthermore, the assembly type is advantageous in that the cam and the shaft can be made of different materials and match characteristics of elements that respectively contact the cam and the shaft.

Particularly, in the case of an assembly type camshaft that is formed of sintered metal powder, there are several advantages in that the bonding strength between the cam and the shaft is comparatively high, and the durability and reliability of the product are superior.

The technical construction of the assembly type camshaft formed of sintered metal powder includes forming a plurality of longitudinal depressions in the circumferential outer surface of the shaft, and providing protrusions on the circumferential inner surface of an insert hole of a cam that is formed of metal powder so that the protrusions are inserted into the corresponding depressions. After the cam is assembled with the shaft, it is sintered and treated with heat of about 1000° C. or more in a furnace so that the cam and the shaft can be firmly joined with each other.

[Document 1] Korean Patent Registration No. 10-0799604

A method of manufacturing a camshaft according to a conventional technique disclosed in Document 1 includes: forming a cam in such a way that at least two protrusions are circumferentially formed on a circumferential inner surface of the cam; pre-sintering the formed cam such that it is maintained at a predetermined temperature; forming at least one protrusion on a surface of the shaft; fitting several pre-sintered cams over the shaft at positions corresponding to preset intervals and at predetermined phase angles and temporarily fastening the cams to the shaft; and main-sintering a product produced by assembling the cam with the shaft such that it is maintained at a predetermined temperature.

As such, the technique of Document 1 includes the pres-sintering operation which is conducted to implement the hardness required for the cam and to enable it to be temporarily assembled with the shaft, and the main-sintering operation which is required to join the cam and the shaft, which have been temporarily fastened together, with each other. Therefore, it takes a long time to manufacture a camshaft.

Furthermore, the technique of Document 1 is disadvantageous in that if it is necessary to increase camshaft production, the number of sintering apparatuses that are very expensive must be increased.

Moreover, in the technique of Document 1, the protrusion that is provided on the outer surface of the shaft is oriented in the longitudinal direction of the shaft. Thus, when fastening the cam to the shaft, a large load is applied to the cam, which may cause a crack in the cam.

Further, in the technique of Document 1, when the main-sintering operation is carried out after the cam has been fastened to the shaft, the shaft may bend. In this case, a separate straightening operation is required to correct the bent shaft.

The volume of the cam contracts by from 5% to 8% because of liquid-phase sintering during the main-sintering operation. Hence, the camshaft that has been sintered needs a comparatively large assembly tolerance. As a result, raw materials are unnecessarily wasted, and the time for processing is increased.

[Document 2 Japanese Patent Laid-open Publication No. Sho 62-6772]

[Document 3 Japanese Patent Laid-open Publication No. Hei. 3-189308]

Techniques of joining a cam with a shaft by brazing them after the cam is fitted over the shaft were proposed in Documents 2 and 3.

However, in the techniques of Documents 2 and 3, the bonding strength between the cam and the shaft is not sufficient. Thus, during the brazing, relative positions of the cam and the shaft may vary. This causes an error in a product after the brazing has been completed.

### PRIOR ART DOCUMENT

### [Patent Document]

(Patent document 1) [Document 1] Korean Patent Registration No. 10-0799604

(Patent document 2) [Document 2] Japanese Patent Laid-open Publication No. Sho 62-6772

(Patent document 3) [Document 3] Japanese Patent Laid-open Publication No. Hei. 3-189308

### DISCLOSURE OF INVENTION

### Technical Problem

Accordingly, the present invention has been made keeping in mind the above problems occurring in the prior art, and an object of the present invention is to provide a method of manufacturing a camshaft in such a way that before a cam is fastened to a shaft, the rupture strength of the cam is increased by main-sintering it, thus preventing a crack from being caused in the cam despite a large fastening load being applied to the cam.

Another object of the present invention is to provide a method of manufacturing the camshaft in which high rupture strength of the cam makes it possible to increase the fastening force, that is, the force with which the cam is temporarily joined with the shaft, thus avoiding a problem of a defective product that pertains to variation in the relative positions between the cam and the shaft during a process of joining the cam with the shaft.

A further object of the present invention is to provide a method of manufacturing the camshaft in which the cam and the shaft which have been temporarily assembled with each other are joined with each other by a brazing process, thereby reducing the time for joining, compared to that of the conventional technique which uses the main-sintering process.

Yet another object of the present invention is to provide a method of manufacturing the camshaft which uses the brazing operation so that the assembly tolerance of the cam and shaft is increased and a phenomenon of the shaft bending during the main-sintering operation is minimized, thereby simplifying the process of manufacturing the camshaft.

### Solution to Problem

In order to accomplish the above objects, the present invention provides a method of manufacturing a camshaft, including: manufacturing a cam, with a depression formed in a circumferential inner surface of the cam; fastening the cam to a shaft in such a way that either the cam or the shaft is rotated relative to a remaining one of the cam and the shaft, the shaft being formed of a hollow pipe, with a protrusion provided on a circumferential outer surface of the shaft; and brazing-joining the cam with the shaft after the fastening, wherein a space is defined between the circumferential outer surface of the shaft and the depression of the cam, the space being used to receive a filler used in the brazing-joining.

In the manufacturing the cam, the cam may be formed by sintering, casting, or forging, or be manufactured into an inner piece cam in which an inner piece that is made of steel equal to or different from a material of the shaft is diffusion-bonded inside the sintered cam.

### Advantageous Effects of Invention

Unlike the conventional technique in which, after an operation of fastening the presintered cam and shaft to each other, they must be main-sintered for a long time for diffusion joining between the cam and the shaft, the present invention uses brazing rather than sintering after the fastening operation, thus markedly reducing the time for manufacturing the camshaft.

Furthermore, when sintering the cam and brazing-joining the cam with the shaft, the charging efficiency can be maximized. Therefore, even if it is necessary to increase camshaft production, increasing the number of sintering apparatuses that are very expensive is not required.

In addition, if the main-sintering operation is conducted after the operation of fastening the cam to the shaft, a phenomenon of the shaft bending may be caused. In this case, a separate straightening operation is required to correct the shaft. However, in the present invention, after the fastening operation, the operation of joining the cam with the shaft is realized by brazing. Thereby, a phenomenon of the shaft bending can be minimized, thus reducing the time for a separate straightening operation.

### BRIEF DESCRIPTION OF DRAWINGS

FIG. 1 is a plan view of a cam;

FIG. 2 is a perspective view of a shaft;

FIG. 3 is a perspective view of a camshaft; and

FIG. 4 is a flowchart.

### MODE FOR THE INVENTION

Hereinafter, a preferred embodiment of the present invention will be described in detail with reference to the attached drawings.

A method of manufacturing a camshaft according to the present invention includes manufacturing a cam 10 in which a depression 12 is formed, and fastening the cam 10 to a shaft 20 provided with a protrusion 21 in such a way that either the cam 10 or the shaft 20 is rotated relative to the other one. After the fastening, the cam 10 is joined with the shaft 20 by brazing rather than sintering.

### [Manufacturing Cam Using Main-Sintering]

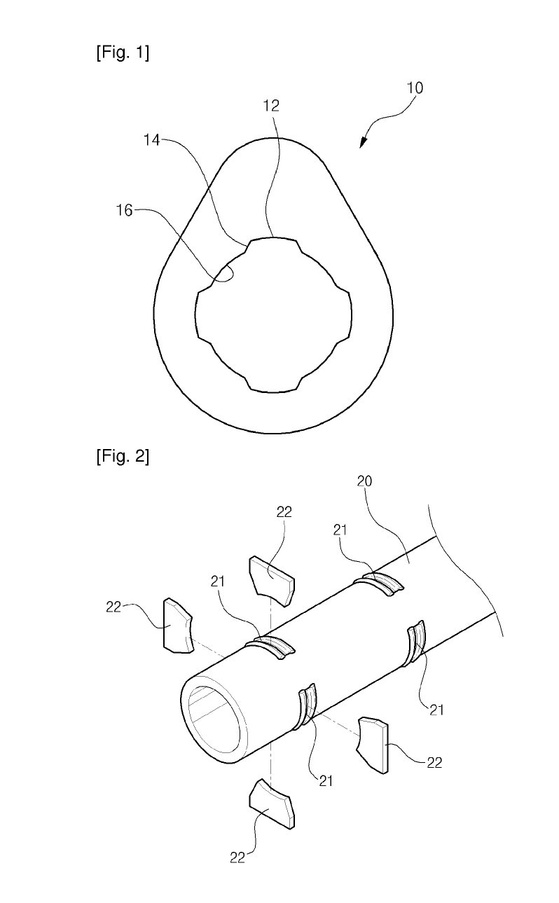

FIG. 1 illustrates a cam 10 having depressions 12 according to the present invention.

The circumferential inner surface of the cam 10 comprises depressions 12 which form a larger diameter, and small diameter portions 16. A ramp 14 is formed between each depression 12 and the adjacent small diameter portion 16.

The cam 10 having the depressions 12 is sintered after it has been formed. In the present invention, the sintering carried out before the cam 10 is assembled with the shaft 20 is main-sintering rather than pre-sintering.

Many kinds of techniques that pertain to such sintering were well known before the present invention is applied, so detailed explanation will be omitted.

In this embodiment, although the cam 10 has been illustrated as being formed by sintering, the cam 10 may be formed by other methods such as forging or casting. Alternatively, the cam 10 may be manufactured in an inner piece cam type in which an inner piece that is made of steel equal to or different from that of the shaft 20 is diffusion-bonded inside the sintered cam 10.

### [Shaft]

FIG. 2 illustrates a shaft 20 used in the present invention. The shaft 20 may comprise a hollow pipe. Recesses are circumferentially formed by recess-forming plates 22 in the circumferential outer surface of the shaft 20. A protrusion 21 is formed adjacent to each recess. Unlike this embodiment, the recess and protrusion 21 which are formed by the recess-forming plates 22 may be longitudinally formed.

In this embodiment, the protrusion 21 extends a predetermined length in the circumferential direction of the shaft 20.

A plurality of protrusions 21 may be circumferentially formed on the circumferential outer surface of the shaft 20.

The length of each protrusion 21 with respect to the circumferential direction of the shaft 20 matches that of the corresponding depression 12 formed in the inner surface of the cam 10. Preferably, the width of the protrusions 21 with respect to the axial direction of the shaft 20 is less than that of the inner surface of the cam 10.

As such, the protrusion 21 of the shaft 20 extends a comparatively long length in the circumferential direction of the shaft 20 so that an area with which the protrusion 21 protrudes is increased, thus markedly enhancing the reliability of fastening the cam 10 to the shaft 20.

### [Fastening the Cam to the Shaft]

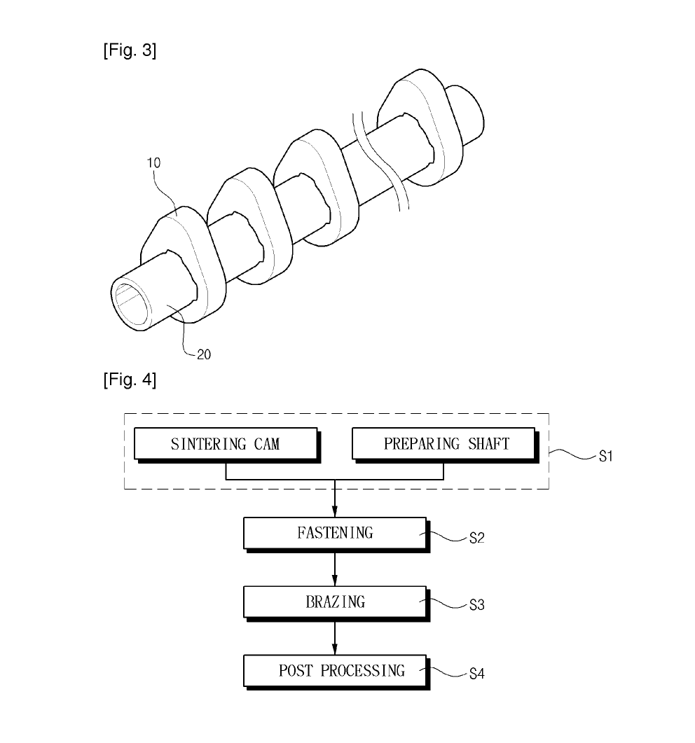

FIG. 3 illustrates the cams 10 and the shaft 20 that are fastened to each other by a fastening operation.

First, the shaft 20 is inserted into the cam 10 such that the protrusions 21 of the shaft 20 are disposed in the corresponding depressions 12 of the cam 10.

In the fastening operation, it is preferable that when the shaft 20 is inserted into the cam 10, the shaft 20 is guided by the ramps 14 of the cam 10.

When the shaft 20 is rotated while the cam 10 is fixed, the protrusions 21 pass over the corresponding ramps 14.

The shaft 20 is rotated with respect to the cam 10 until the protrusions 21 of the shaft 20 are disposed in the corresponding small diameter portions 16 formed in the inner surface of the cam 10.

The cam 10 and the shaft 20 are fastened to each other by this rotation.

Of course, fastening the cam 10 to the shaft 20 can be realized by rotating the cam 10 while the shaft 20 is fixed.

When the rotation of the shaft 20 relative to the cam 10 is completed, a space is determined between the circumferential outer surface of the shaft 20 and each depression 12 of the cam 10.

Unlike the conventional technique, the cam 10 according to the present invention is formed by main-sintering. Thus, the hardness of the cam 10 according to the present invention is higher than that of the conventional technique. This reduces the possibility of a crack problem which may be caused in the operation of fastening the cam 10 to the shaft 20.

Furthermore, in the present invention, the protrusions of the shaft 20 extend long in the circumferential direction of the shaft 20, so that the force by which the cam 10 and the shaft 20 are fastened to each other can be enhanced.

In addition, when the shaft 20 is rotated so that the cam 10 and the shaft 20 are assembled with each other, so as to minimize stress generated by the protrusions 21 that are circumferentially provided on the circumferential outer surface of the shaft 20, the ramp 14 is formed on an end of each depression 12 of the cam 10. Therefore, the present invention can prevent a crack from being caused in the cam 10 during the assembly, thus minimizing the number of defective products.

[Brazing-joining the Cam with the Shaft]

After the cam 10 has been reliably fastened to the shaft 20 in such a way that the cam 10 and the shaft 20 are rotated relative to each other, the cam 10 is joined with the shaft 20 by brazing rather than sintering. A Ni- or Fe-based filler metal or the like can be used in the brazing.

The brazing-joining is a technology which has been well known before the present invention is applied, so its detailed description will be skipped (refer to Japanese Laid-open Publication No. Sho 62-6772, Japanese Laid-open Publication No. Hei. 3-189308, etc.)

The brazing-joining is completed within thirty minutes. Hence, compared to the conventional technique in which the cam or camshaft must be processed by pre- and main-sintering for a long time, the present invention can markedly reduce the time for manufacturing.

In the camshaft that is formed by the operation of fastening the cam 10 to the shaft 20, a space is defined between the circumferential outer surface of the shaft 20 and each depression 12 of the cam 10. This space can be used as a space which receives filler required when brazing-joining.

As such, after the fastening operation, the cam 10 and the shaft 20 are joined with each other by brazing rather than sintering. Thus, the present invention can minimize the problem of the shaft bending when main-sintering which has been caused in the conventional technique.

### [Summary of the Process of the Present Invention]

FIG. 4 briefly illustrates the entire process of the present invention.

In a first operation S1, the cam 10 is manufactured by main-sintering, and the shaft 20 is prepared.

In a second operation S2, the cam 10 and the shaft 20 are rotated relative to each other so that they are fastened to each other.

The fastening operation is conducted in such a way that the protrusions 21 that extend long in the circumferential direction of the shaft 20 are circumferentially rotated.

In the fastening operation, it is preferable that when the shaft 20 is inserted into the cam 10, the ramps 14 of the cam 10 guide the shaft 20.

In a third operation S3, the cam 10 and the shaft 20 of the cam-shaft assembly that is formed by the fastening operation are joined with each other by brazing rather than sintering.

In other words, the third operation S3 is an operation of brazing the cam 10 and the shaft 20 that have been strongly fastened to each other by the rotation of the protrusions 21 that extend long in the circumferential direction of the shaft 20 in the prior operation, that is, the fastening operation, thus completing the joining between the cam 10 and the shaft 20.

In a fourth operation S4, a post-process required for the joined camshaft is conducted.

### INDUSTRIAL APPLICABILITY

A camshaft manufactured by the present invention can be used in an engine for vehicles.

1. A method of manufacturing a camshaft, comprising:
manufacturing a cam, with a depression formed in a circumferential inner surface of the cam;
fastening the cam to a shaft in such a way that either the cam or the shaft is rotated relative to a remaining one of the cam and the shaft, the shaft being formed of a hollow pipe, with a protrusion provided on a circumferential outer surface of the shaft; and
brazing-joining the cam with the shaft after the fastening, wherein a space is defined between the circumferential outer surface of the shaft and the depression of the cam, the space being used to receive a filler used in the brazing-joining.

2. The method according to claim 1, wherein in the manufacturing the cam, the cam is formed by sintering, casting, or forging, or is manufactured into an inner piece cam in which an inner piece that is made of steel equal to or different from a material of the shaft is diffusion-bonded inside the sintered cam.
